(19) United States
(12) Patent Application Publication
(10) Pub. No.: US 2007/0084596 A1
(43) Pub. Date: Apr. 19, 2007

(54) Vehicle air conditioner with variable displacement compressor

(75) Inventor: Akira Umehara, Toyota-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/524,421

(22) Filed: Sep. 20, 2006

(30) Foreign Application Priority Data
Oct. 13, 2005 (JP) 2005-299246

(51) Int. Cl. B60H 1/00; F25B 49/00

(52) U.S. Cl. 165/202; 62/228.1

(57) ABSTRACT

An air conditioner includes a variable displacement compressor that compresses refrigerant from an evaporator and varies a displacement according to a pressure in its control pressure chamber, and an electromagnetic valve that changes an opening such that the displacement of the refrigerant is increased in accordance with an increase in a value of current passing therethrough and changes a pressure state applied into the control pressure chamber. A control unit computes a target cooling temperature of air cooled by the evaporator, and adjusts the value of current passing through the electromagnetic valve to control the displacement so that the air temperature cooled by the evaporator approaches to the target cooling temperature. Furthermore, the control unit sets the value of current passing through the electromagnetic valve at a current value equal to or higher than a predetermined value that is determined based on an operation characteristic of the electromagnetic valve.

### CROSS REFERENCE TO RELATED APPLICATION

This application is based on Japanese Patent Application No. 2005-299246 filed on Oct. 13, 2005, the contents of which are incorporated herein by reference in its entirety.

### FIELD OF THE INVENTION

The present invention relates to a vehicle air conditioner in which a refrigeration cycle is constructed with a variable displacement compressor. More particularly, the present invention relates to a compression device having a variable displacement compressor for a refrigerant cycle system.

### BACKGROUND OF THE INVENTION

As one of conventional arts, there is a vehicle air conditioner disclosed in JP-2005-104305A (corresponding to US 2005/0066669 A1). A compressor adopted in this vehicle air conditioner is an external variable displacement compressor that has an electromagnetic displacement control valve (electromagnetic valve) controlled by electrical signals from a control device and is so constructed that a control pressure is varied by this electromagnetic valve to vary a displacement.

Specifically, the electromagnetic valve that reduces a valve opening in proportion to increase in control current is provided in a path for transmitting refrigerant discharge pressure to a swash plate chamber as a control pressure chamber. The valve opening of the electromagnetic valve is adjusted by control current to vary the pressure in the swash plate chamber. The angle of inclination of the swash plate placed in the swash plate chamber is thereby varied to vary the stroke of the piston coupled with the swash plate.

However, the displacement control in the compressor in a vehicle air conditioner involves a problem. When the output of the control current is started and the electromagnetic valve in open state starts closing, the compressor does not discharge refrigerant until the value of the control current increases to some degree.

The present inventors studied possible causes of this problem, and found the following: because of pressure applied to the electromagnetic valve and resulting increase in frictional force, the start of operation of the electromagnetic valve was delayed until the value of the control current increased to some degree. In cases where the value of the control current is determined without taking into account delay in the start of operation of the electromagnetic valve, when the flow amount requirement for the compressor is low, the piston of the compressor remains resting, and cooling or dehumidifying operation cannot be favorably performed.

There is known such variable control for variable displacement compressors as described in JP-2001-191789A (corresponding to U.S. Pat. No. 6,537,037). This control is such that, when a duty ratio for driving a variable displacement compressor is lower than a predetermined determination value, the compressor is operated with the minimum displacement. For this reason, compression operation is maintained even when a duty ratio is low. In JP-2001-191789A, the minimum displacement is determined so that the compressor is not operated with a low coefficient of performance (COP), using inflection points in cooling performance ratio and duty ratio as determination value. However, in cases where a minimum displacement is determined with the emphasis on the coefficient of performance (COP) of the compressor, as mentioned above, the minimum displacement increases to some degree. Accordingly, if discontinuous control is carried out to repeatedly turn on and off a compressor for the purpose of preventing frosting in an evaporator, the change in the displacement of the compressor leads to fluctuation in power torque to an engine that drives the compressor. As a result, the driver has uncomfortable feeling in the driving operation.

### SUMMARY OF THE INVENTION

The invention has been made with the above problems taken into account. A first object of the present invention is to provide a vehicle air conditioner in which, even when a start of operation of an electromagnetic valve is delayed, cooling and dehumidifying operations can be effectively performed.

A second object of the present invention is to provide a vehicle air conditioner, which can prevent an uncomfortable feeling given to a driver in a driving operation even when a control for preventing frosting in a heat exchanger (i.e., en evaporator) is carried out.

A third object of the present invention is to provide a compression device having a variable displacement compressor for a refrigerant cycle system.

According to an aspect of the present invention, an air conditioner for a vehicle includes a heat exchanger that cools air to be blown into a compartment of the vehicle, a temperature detecting member that detects a temperature relative to an air temperature cooled at the heat exchanger, and a variable displacement compressor having a control pressure chamber. The compressor compresses and discharges refrigerant passed through the heat exchanger, and varies a displacement according to a pressure in the control pressure chamber. An electromagnetic valve changes an opening such that the displacement of the refrigerant is increased in accordance with an increase in a value of current passing therethrough, and changes a pressure state applied into the control pressure chamber. Furthermore, a control unit computes a target cooling temperature used when air to be blown into the compartment is cooled by the heat exchanger, and adjusts the value of current passing through the electromagnetic valve to control the displacement so that the temperature detected by the temperature detecting member approaches to the target cooling temperature. In addition, the control unit sets the value of current passing through the electromagnetic valve at a current value equal to or higher than a predetermined value that is determined based on an operation characteristic of the electromagnetic valve.

Accordingly, the value of current passed through an electromagnetic valve can be set to a value equal to or higher than the predetermined value based on the operation characteristics of the electromagnetic valve. Thus, it is possible to avoid a state in which a current is passed with a low current value so that the electromagnetic valve produces operation start delay. Therefore, even when an electromagnetic valve involving operation start delay is used, the problem that the compressor does not discharge refrigerant is less prone to occur. It is possible to effectively cool the air blown into the vehicle compartment by the heat exchanger so that the target cooling temperature can be obtained. Thus, the vehicle compartment can be favorably cooled or dehumidified.

Since the value of passed current and the lower limit of refrigerant displacement are determined based on the operation characteristic of the electromagnetic valve, the value of passed current can be determined at a lower level than in cases where a lower limit of the refrigerant displacement of a compressor is determined with the emphasis on coefficient of performance COP. For this reason, even when discontinuous control is carried out to repeatedly turn on and off the compressor for the purpose of preventing frosting in the heat exchanger, change in the displacement of this compressor does not cause great influence on fluctuation in power torque to a vehicle engine. As a result, the driver can be prevented from having uncomfortable feeling in the driving operation.

For example, the control unit sets the predetermined value at a substantially lowest value at which the electromagnetic valve is operatable, or at a constant value. Alternatively, a discharge pressure detecting member may be provided to detect a refrigerant discharge pressure of the compressor. In this case, the electromagnetic valve is provided in a path for transmitting the refrigerant discharge pressure to the control pressure chamber, and the control unit varies the predetermined value according to the refrigerant discharge pressure detected by the discharge pressure detecting member. Furthermore, the control unit may vary the predetermined value according to a value obtained by subjecting the refrigerant discharge pressure detected by the discharge pressure detecting member to a time constant smoothing. Alternatively, the control unit varies the predetermined value according to the value of voltage applied to the electromagnetic valve.

According to an another aspect of the present invention, a compression device for a refrigerant cycle system includes a variable displacement compressor having a control pressure chamber, an electromagnetic valve and a control unit. In the compression device, the compressor compresses and discharges refrigerant, and varies a displacement according to a pressure in the control pressure chamber. The electromagnetic valve changes an opening such that the displacement of the refrigerant from the compressor is increased in accordance with an increase in a value of current passing therethrough, and changes a pressure state applied into the control pressure chamber. The control unit computes a target cooling load in a heat exchanger of the refrigerant cycle system, and adjusts the value of current passing through the electromagnetic valve to control the displacement. In addition, the control unit sets the value of current passing through the electromagnetic valve at a current value equal to or higher than a predetermined value that is determined based on an operation characteristic of the electromagnetic valve. Accordingly, the value of current passed through an electromagnetic valve can be set to a value equal to or higher than the predetermined value based on the operation characteristics of the electromagnetic valve. Thus, it is possible to avoid a state, in which a current is passed with a low current value so that the electromagnetic valve causes operation start delay.

### BRIEF DESCRIPTION OF THE DRAWINGS

Additional objects and advantages of the present invention will be more readily apparent from the following detailed description of preferred embodiments when taken together with the accompanying drawings.

FIG. 1 is a schematic diagram illustrating the overall system configuration of a vehicle air conditioner in a first embodiment of the present invention.

FIG. 2 is a sectional view of a compressor used in the vehicle air conditioner.

FIG. 3 is a schematic diagram for explaining an external variable control method for a compressor.

FIG. 4 is a flowchart schematically illustrating the operation performed by an ECU when it controls a compressor in the first embodiment.

FIG. 5 is a graph showing the relation between the value of control current and piston stroke (corresponding to the opening of an electromagnetic valve) as an example.

FIG. 6 is a schematic diagram illustrating the overall system configuration of a vehicle air conditioner in a second embodiment of the present invention.

FIG. 7 is a flowchart schematically illustrating a part of the operation performed by an ECU when it controls a compressor in the second embodiment.

FIG. 8 is a graph showing the relation between a refrigerant discharge pressure and the lowest value of control current.

FIG. 9 is a schematic diagram illustrating a part of a vehicle air conditioner in another embodiment.

### DETAILED DESCRIPTION OF THE PREFERRED EMBODIMENTS

Hereafter, description will be given to embodiments of the present invention with reference to drawings.

(First Embodiment)

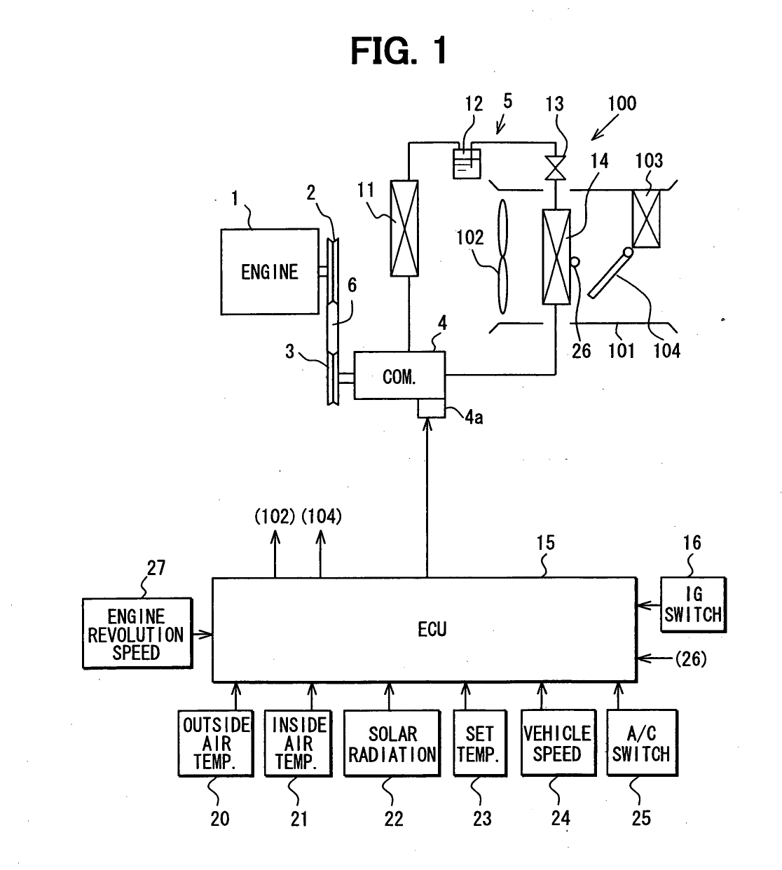

As illustrated in FIG. 1, an output shaft of an engine 1 is provided with a driving pulley 2. This driving pulley 2 is so constructed that it is rotated in conjunction with driving of the engine 1.

Around the driving pulley 2 and a driven pulley 3, there is threaded a belt 6 as a power transmission member. A compressor 4 is a variable displacement compressor, that is one of the components of the refrigeration cycle 5 mounted in the relevant vehicle.

The compressor 4 is not provided with an electromagnetic clutch or the like as a power connecting/disconnecting means, and is constantly driven by the engine 1. The compressor 4 is so constructed that its displacement can be varied substantially within the range of 0 to 100% according to a number of engine revolutions and a cooling load.

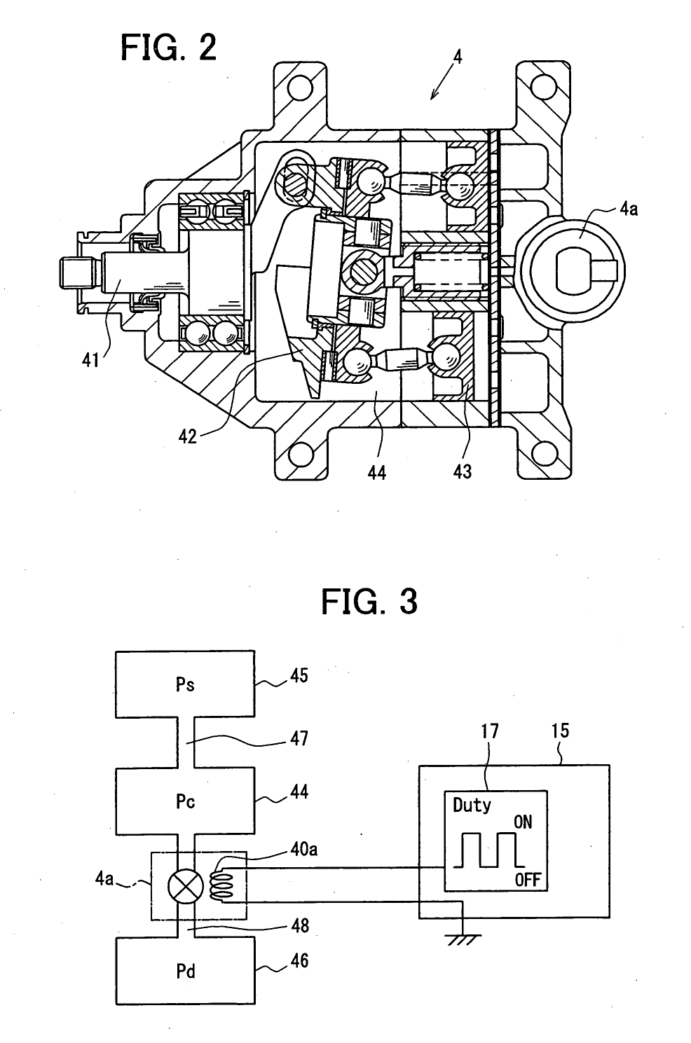

Brief description will be given to the refrigeration cycle 5 including the compressor 4. As illustrated in FIG. 2, the compressor 4 is a swash plate-type external variable displacement compressor.

Numeral 41 denotes a shaft as the rotating shaft of the compressor 4, and the above-described driven pulley 3 is connected to the left end of this shaft 41 in FIG. 2. The compressor 4 is so constructed to drive a compression mechanism constructed of pistons 43 by rotation of a swash plate 42, and to compress and discharge sucked refrigerant.

The variable displacement mechanism itself of the compressor 4 is generally known. To vary the displacement of the compressor 4, the pressure in the swash plate chamber 44, in which the swash plate 42 is housed, is varied to vary the angle of inclination of the swash plate 42, and the stroke of the pistons 43 is thereby changed.

When the pressure in the swash plate chamber 44 is reduced, the angle of inclination of the swash plate 42 is increased. As a result, the stroke of the pistons 43 is increased, and the displacement is increased. When the pressure in the swash plate chamber 44 is increased, the angle of inclination of the swash plate 42 is reduced. As a result, the stroke of the pistons 43 is reduced, and the displacement is reduced.

The compressor 4 includes an electromagnetic valve (electromagnetic pressure control valve) 4a. The compressor 4 is so constructed that the pressure in the swash plate chamber 44 that functions as a control pressure chamber is adjusted according to the opening of this electromagnetic valve 4a.

As illustrated in FIG. 3, the swash plate chamber 44 as a control pressure chamber communicates with a suction chamber 45 provided on the refrigerant suction side of the compression mechanism of the compressor 4 through a communicating path (throttling communicating path) 47. The swash plate chamber 44 also communicates with a discharge chamber 46 provided on the refrigerant discharge side of the compression mechanism of the compressor 4 through a communicating path (throttling communicating path) 48.

The electromagnetic valve 4a is provided in the communicating path 48. The electromagnetic valve 4a is an electromagnetic solenoid valve, and is constructed such that: the valve 4a is fully opened when power is not applied to its solenoid coil 40a from the current output circuit 17 of a control device 15 to be described; and its opening is reduced as the value of current passed through the solenoid coil 40a increases.

When the electromagnetic valve 4a is fully open, the refrigerant discharge pressure Pd of the discharge chamber 46 is applied to the interior of the swash plate chamber 44 through the communicating path 48. The pressure Pc in the swash plate chamber 44 takes a relatively high value between the refrigerant discharge pressure Pd and a refrigerant suction pressure Ps. In conjunction with this, the angle of inclination of the swash plate 42 in the swash plate chamber 44 is reduced, and the refrigerant displacement becomes very small.

Meanwhile, as the opening of the electromagnetic valve 4a is reduced, the refrigerant discharge pressure Pd applied to the interior of the swash plate chamber 44 is lowered, and the pressure Pc in the swash plate chamber 44 lowers between the refrigerant discharge pressure Pd and the refrigerant suction pressure Ps. In conjunction with this, the angle of inclination of the swash plate 42 in the swash plate chamber 44 is increased, and the refrigerant displacement is increased as well.

In addition to the above-described compressor 4, as illustrated in FIG. 1, the refrigeration cycle 5 includes: a condenser 11 that condenses and liquefies refrigerant compressed at the compressor 4; a liquid receiver 12 that separates condensed and liquefied refrigerant into vapor-phase refrigerant and liquid-phase refrigerant; an expansion valve (depressurizing device) 13 that depressurizes and expands liquid-phase refrigerant from the liquid receiver 12; and an evaporator 14 that evaporates and vaporizes depressurized refrigerant.

The evaporator 14 is a heat exchanger for cooling of the vehicle air conditioner 100 that performs air conditioning in a compartment of a vehicle. The vehicle air conditioner 100 has an air conditioner case 101 that defines an air passage to the interior of the vehicle compartment. In the air conditioner case 101, a blower 102 for blowing air into the vehicle compartment through the air passage, and the evaporator 14 for cooling the air passing therethrough. Downstream of the evaporator 14, a heater core 103 for heating air and an air mix door 104 that adjusts the temperature of air are located in the air conditioner case 101. The heater core 103 uses engine-cooling water as a heat source. The air mix door 104 adjusts the temperature of air to be introduced into the vehicle compartment by adjusting a flow ratio between an air amount passing through the heater core 103 and an air amount bypassing the heater core 103.

The compressor 4 is controlled by an air conditioning control device (hereafter referred to as ECU) 15 as a controlling means. The ECU 15 is supplied with power from an in-vehicle battery, not shown, when an ignition switch 16 for enabling running of the vehicle is turned on.

The ECU 15 is connected with: an outside air temperature sensor 20 that is a means for detecting the temperature of the exterior of the vehicle compartment (outside air temperature); an inside air temperature sensor 21 that is a means for detecting the temperature of the interior of the vehicle compartment (inside air temperature); a solar sensor 22 that is a means for detecting a value of solar radiation entering into the interior of the vehicle compartment; and a temperature setting unit 23 for setting an air conditioning temperature in the vehicle compartment. Thus, the ECU is so constructed that temperature information, value of solar radiation information, setting information, and the like are inputted to it.

For example, the outside air temperature sensor 20 is so constructed that its electrical resistance varies according to a sensor outside air temperature. The outside air temperature sensor 20 sends out this variation as an electrical signal to the ECU 15 that is responsible for air conditioning control. The ECU 15 uses values obtained as the result of averaging in control so that it is not influenced by electrical noise.

Further, the ECU 15 is connected with: a vehicle speed sensor 24 that is a means for detecting a vehicle speed; an air conditioner switch 25 (A/C switch) for giving an instruction to operate the refrigeration cycle 5; a temperature sensor 26 that detects the temperature of air passed through the evaporator 14; a revolutions sensor 27 as a revolution speed detecting means that detects the revolution speed of the engine 1; and the like. The ECU is so constructed that varied detection information is inputted to it.

For example, the temperature sensor 26 is a sensor that is installed on an outer fin of the evaporator 14 and detects a fin temperature, and its electrical resistance is varied according to the fin temperature. For example, the evaporator 14 includes a plurality of tubes in which refrigerant flows, and a plurality of fins between the tubes. In this case, the temperature sensor 26 is located to contact the fin so as to detect the fin temperature. The temperature sensor 26 sends out this variation as an electrical signal to the ECU 15. The ECU 15 uses values obtained as the result of averaging in control processing so that it is not influenced by electrical noise. However, the number of times of processing is reduced so that the evaporator 14 is not frosted.

When air is being passed through the evaporator 14, the temperature of air cooled at the evaporator 14 substantially corresponds with the temperature of the outer fin of the evaporator 14. Therefore, the temperature sensor 26 is a temperature detecting means for detecting the temperature of air cooled at the evaporator 14.

Based on inputted varied information, the ECU 15 outputs control signals to the compressor 4, the air blower 102, the air mix door 104, and the like.

As illustrated in FIG. 3, the ECU 15 has the current output circuit (displacement control circuit) 17 for outputting control signals to the compressor 4. This control circuit 17 is an electrical circuit that periodically applies and interrupts the application of (turns on and off) the supply voltage, applied to the ECU 15, to the solenoid coil 40a of the electromagnetic valve 4a in the compressor 4, and passes constant currents through it. The cycle of turning on/off is determined beforehand based on the inductance of the solenoid coil 40a, and is a frequency of 400 Hz, for example.

Description will be given to the air conditioning control carried out by the ECU 15.

The ECU 15 reads a set temperature set by the temperature setting unit 23, and temperatures and the like detected by the various sensors, including the outside air temperature sensor 20, the inside air temperature sensor 21, the solar sensor 22, the temperature sensor 26, the coolant temperature sensor, not shown, and the like. Thus, the ECU 15 computes a temperature of air (target air temperature) TAO required for making the temperature of the interior of the vehicle compartment equal to the set temperature.

Based on preset relation, the ECU 15 controls the air blower 102, the air mix door 104, an air outlet mode door, not shown, and the like according to the computed target air temperature TAO. When the air conditioner switch 25 is on, the ECU 15 controls the displacement of the compressor 4.

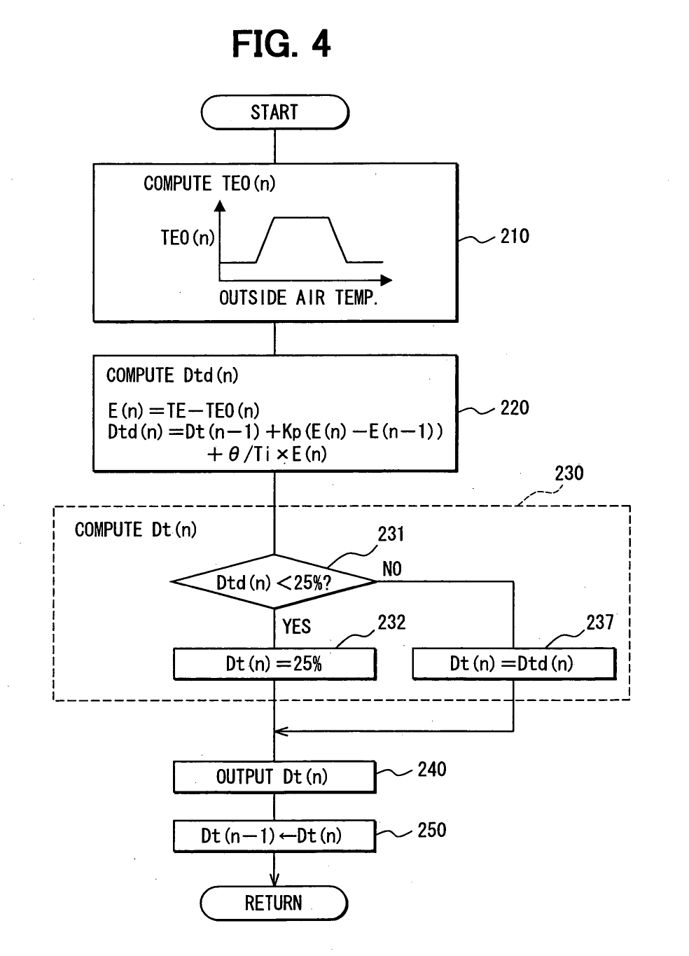

Control of the compressor 4 will be described with reference to FIG. 4. FIG. 4 is a flowchart schematically illustrating the operation performed by the ECU 15 when it controls the compressor 4.

As illustrated in FIG. 4, first, the ECU 15 computes a predetermined target value TEO(n) of an evaporator temperature based on information inputted from the outside air temperature sensor 20, the inside air temperature sensor 21, the solar sensor 22, the temperature setting unit 23, and the like (Step 210). The target value TEO(n) of the evaporator temperature is a target temperature used when the evaporator 14 cools the air passing through it. The symbol TEO(n) cited here represents the target value for this time (n) of those periodically computed.

With respect to outside air temperature, a target temperature TEO(n) is computed as illustrated at Step 210 in the drawing. This target value is determined beforehand by testing or the like, based on defogging of window glass at a low outside air temperature and the cooling performance at a high outside air temperature.

After carrying out the processing of Step 210, the ECU computes a first control current value (first control current duty) Dtd(n) that is a tentative control current value for passing a current through the electromagnetic valve 4a (Step 220). Using Expressions 1 and 2 below, the ECU 15 carries out the computation so that the evaporator temperature TE detected by the temperature sensor 26 approaches to the target value of evaporator temperature TEO(n) computed at Step 210:
E(n)=TE−TEO(n) (Expression 1)
Dtd(n)=Dt(n−1)+Kp(E(n)−E(n−1))+θ/TixE(n) (Expression 2)

This computation is a Pi (integral) computation, and the operation period is set to one second. Here, Dt(n−1) is the second control current value, to be described, computed in the previous computation; and Kp and θ/Ti are constants determined beforehand by testing or the like so that the evaporator temperature TE and the target value of evaporator temperature TEO(n) become equal to each other in a minimum time without causing hunting or overshoot.

With respect to the evaporator temperature TE used in the computation at Step 220, in order to accurately detect the state of the evaporator 14, among the temperatures detected by temperature sensor 26 every 40 ms, for example, the detection values obtained in the most recent four times of detection are averaged, and this averaged value is adopted.

After carrying out the processing of Step 220, the ECU computes a second control current value (second control current duty) Dt(n) that is an actual control current value (true control current value) for passing a current through the electromagnetic valve 4a (Step group 230).

In Step group 230, the ECU 15 carries out the following processing. First, it determines whether or not the first control current value Dtd(n) computed at Step 220 is lower than 25% (Step 231). As mentioned above, the control current value is set by duty ratio, and both the first control current value Dtd(n) and the second control current value Dt(n) are represented as the ratio of on-time to one on/off period.

In a case where the ECU 15 determines at Step 231 that the first control current value Dtd(n) is lower than 25%, it sets the second control current value Dt(n) to 25% (Step 232). In a case where the ECU 15 determines that the first control current value Dtd(n) is equal to or higher than 25%, it takes the first control current value Dtd(n) as the second control current value Dt(n) (Step 237).

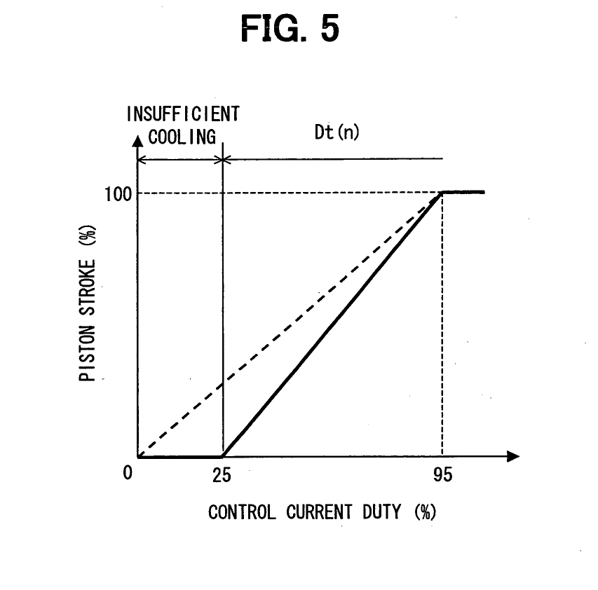

The duty of 25% taken as the criterion at Step 231 is a true control current value used when driving of the compressor 4 is started, determined beforehand by an experiment or the like. With a duty less than 25%, when the electromagnetic valve 4a in closed state starts opening, the electromagnetic valve 4a does not favorably operate, and refrigerant is not favorably discharged. (Refer to the solid line in FIG. 5.)

To cope with this, Step group 230 in this embodiment, the step to compute the second control current value Dt(n) is divided on the basis of the lowest value 25% at which the electromagnetic valve 4a can operate, so that the second control current value Dt(n) is prevented from becoming less than 25%.

After carrying out the processing of Step group 230, as mentioned above, the ECU 15 outputs the second control current value Dt(n) from its current output circuit 17 to the solenoid coil 40a of the electromagnetic valve 4a (Step 240).

In preparation for the next computation of the first control current value Dtd(n), the ECU 15 substitutes the second control current value Dt(n) outputted at Step 240 for Dt(n−1) (Step 250), and returns to Start.

With the above-described construction and according to the above-described operation, when the computed first control current duty Dtd(n) is lower than the true compressor 4 operation start value (25% in the example illustrated in FIG. 5) determined beforehand by an experiment or the like, the second control current duty Dt(n) outputted to the electromagnetic valve 4a that controls the refrigerant flow amount of the compressor 4 can be set to 25% that is the value for starting driving of the compressor 4. In the other cases, the first control current duty Dtd(n) can be taken as the second control current duty Dt(n) without change.

Accordingly, a value within the range of 0 to less than 25%, which is the control current output range in which the compressor 4 cannot discharge refrigerant, is not computed as the second control current duty Dt(n), and the ECU 15 can constantly pass a minimum amount of refrigerant essentially required as a result of thermal load computation through the refrigeration cycle 5.

As mentioned above, the second control current duty Dt(n) for the electromagnetic valve 4a is set to a value equal to or higher than the lowest value based on the operation characteristics of the electromagnetic valve 4a. Thus, a state, in which a current is passed with a low current value so that the electromagnetic valve 4a produces operation start delay, can be avoided. Therefore, even when an electromagnetic valve 4a involving operation start delay is used, the air blown into the vehicle compartment can be cooled by the evaporator 14 so that the target cooling temperature TEO can be obtained. As a result, the interior of the vehicle compartment can be effectively cooled or dehumidified.

For example, in cases where it is desired to obtain a minimum dehumidifying effect while saving power, dehumidifying operation cannot effectively be performed with related arts because a current is outputted in a range in which a compressor cannot discharge refrigerant. In this embodiment, however, a current is not outputted in the refrigerant undischargeable range, and only currents with which refrigerant is discharged without fail are controlled. Therefore, dehumidification can be carried out, and fogging can be accurately prevented.

Also, in cases where it is desired to carry out required minimum dehumidification while saving power in intermediate seasons, comfortable air conditioning can be provided without giving uncomfortable feeling to the occupants.

When the first control current duty Dtd(n) is less than 25%, the second control current duty Dt(n) is set to 25%, so that the electromagnetic valve 4a can operate with the lowest value. Thus, excessive discharge of refrigerant can be suppressed, and an amount of energy consumption can be reduced.

The determination value at which the flow of control for the computation of the second control current duty Dt(n) is divided is made constant. Therefore, the control is very simple.

The refrigerant flow amount required for the ECU 15 can also be provided as actual torque information on the compressor 4 to an engine control device (engine ECU), not shown, at the same time. In this embodiment, the ECU 15 produces current output matched with a refrigerant flow amount; therefore, actual torque information without deviation can be provided to the engine ECU, and a number of idling revolutions can be accurately adjusted when the vehicle is at a stop.

(Second Embodiment)

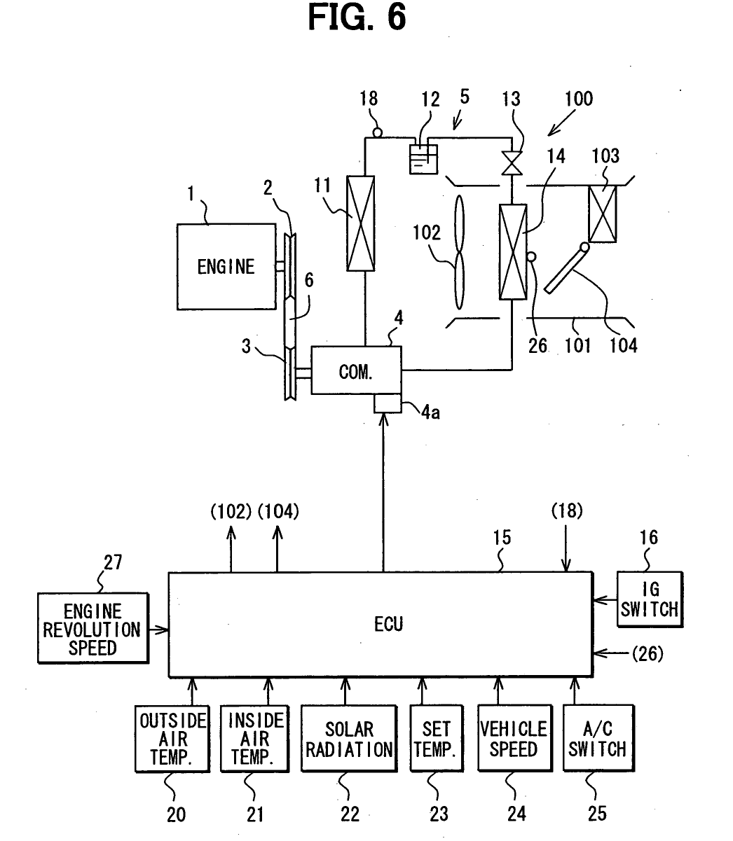

Description will be given to a second embodiment with reference to FIG. 6 to FIG. 8.

The second embodiment is different from the first embodiment in that a control current value is corrected based on fluctuation in refrigerant discharge pressure. The same members as in the first embodiment will be indicated with the same reference numerals, and the description of them will be omitted.

Though the description has been omitted with respect to the first embodiment, the refrigeration cycle 5 of the vehicle air conditioner 100 in this embodiment is constructed as illustrated in FIG. 6. In the high-pressure circuit portion running from the discharge side of the compressor 4 to the inlet of the expansion valve 13, there is provided a pressure sensor 18 that is a discharge pressure detecting means for detecting high pressure (compressor refrigerant discharge pressure). In the example illustrated in FIG. 6, the pressure sensor 18 is provided in the refrigerant pipe on the outlet side of the condenser 11. The refrigeration cycle is so constructed that the detection signals of this pressure sensor 18 are also inputted to the ECU 15.

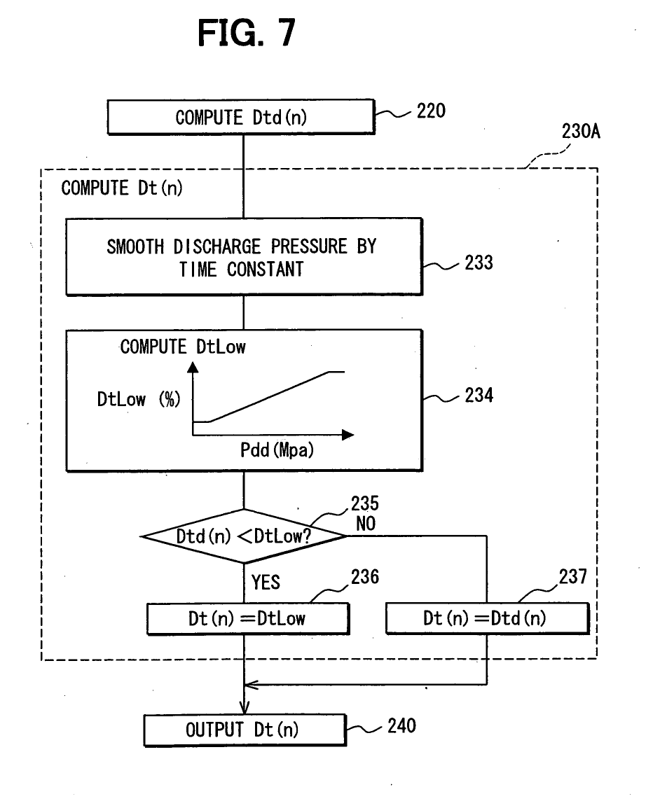

Description will be given to the compressor control carried out by the ECU 15 in this embodiment based on the above-described construction. FIG. 7 is part of a flowchart schematically illustrating the operation performed by the ECU 15, for controlling the compressor 4.

As illustrated in FIG. 7, after carrying out the processing of Step 220 to compute the first control current value Dtd(n), the ECU 15 carries out the processing of Step group 230A to compute the second control current value Dt(n).

At Step group 230A, first, the ECU 15 determines a refrigerant pressure value Pd from an electrical signal (voltage value) from the pressure sensor 18. This pressure value detected by the pressure sensor 18 largely fluctuates. Therefore, a pressure value Pdd is computed by adding a time constant of 63.2% control response to the pressure value Pd so as to smooth the obtained value (Step 233). Though 63.2% control response is adopted as a method for smoothing (selecting) in this example, any other technique may be adopted. For example, ascent and descent limitations per unit time may be used for the detected refrigerant pressure Pd.

After carrying out the processing of Step 233, the ECU 15 computes the lowest control current value (lowest control current duty) DtLow of the electromagnetic valve 4a corresponding to the calculated discharge pressure Pdd (Step 234).

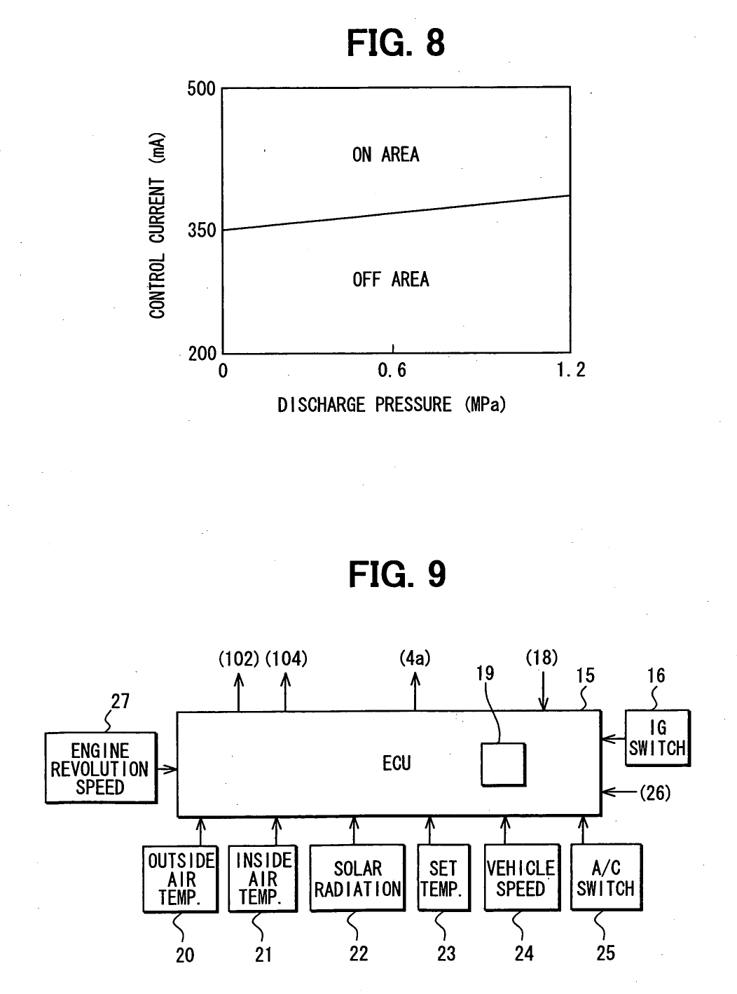

As illustrated in FIG. 8, the true control current value used at a driving start time of the compressor 4, at which the compressor 4 can start discharging refrigerant, is proportionally varied by discharge pressure. That is, it has been verified that the control current value at which the electromagnetic valve 4a in closed state starts opening increases with increase in refrigerant discharge pressure. This control current value is a boundary value between the ON region and the OFF region in FIG. 8.

At Step 234, consequently, the relation between the control current value DtLow at which driving of the compressor 4 is started, computed beforehand by an experiment or the like, and the calculated refrigerant discharge pressure Pdd is set in the form of computational expression or map value. Then, the lowest control current value DtLow of the electromagnetic valve 4a corresponding to the calculated refrigerant discharge pressure Pdd is computed.

After carrying out the processing of Step 234, the ECU 15 determines whether or not the first control current value Dtd(n) computed at Step 220 is lower than the lowest control current value DtLow (Step 235). In a case where the ECU 15 determines at Step 235 that the first control current value Dtd(n) is less than the lowest control current value DtLow, it takes the second control current value Dt(n) as the lowest control current value DtLow (Step 236). In a case where the ECU 15 determines that the first control current value Dtd(n) is equal to or higher than the lowest control current value DtLow, it takes the first control current value Dtd(n) as the second control current value Dt(n) (Step 237).

After carrying out the processing of Step group 230A, as mentioned above, the ECU 15 proceeds to Step 240 as in the first embodiment. Then, it outputs the second control current value Dt(n) to the solenoid coil 40a of the electromagnetic valve 4a.

With the above-described construction and according to the above-described operation, when the computed first control current duty Dtd(n) is lower than the true diving start value of the compressor 4, determined beforehand by an experiment or the like, the second control current duty Dt(n) outputted to the electromagnetic valve 4a that controls the refrigerant flow amount of the compressor 4 can be set to the lowest control current duty DtLow, the value for starting driving of the compressor 4. Here, the lowest control current duty DtLow corresponds to the calculated refrigerant discharge pressure Pdd. In the other cases where the computed first control current duty Dtd(n) is not lower than the lowest control current duty DtLow, the first control current duty Dtd(n) can be taken as the second control current duty Dt(n) without change.

Accordingly, a value within the range of 0 to less than DtLow, in which the compressor 4 cannot discharge refrigerant, is not computed as the second control current duty Dt(n); and the ECU 15 can constantly pass a minimum amount of refrigerant, essentially required as a result of thermal load computation, through the refrigeration cycle 5.

As mentioned above, the lowest control current value can be changed in correspondence with fluctuation in refrigerant discharge pressure that is the source of pressure applied to the swash plate chamber 44 as a control pressure chamber. Thus, excessive discharge of refrigerant can be suppressed to reduce an amount of energy consumption without fail, and the problem that the compressor 4 does not discharge refrigerant can be prevented.

The pressure value Pdd, obtained by subjecting a pressure value Pd detected by the pressure sensor 18 to time-constant smoothing, is used as the discharge pressure when the lowest control current value DtLow is computed. Therefore, even when a refrigerant discharge pressure detected by the pressure sensor 18 largely fluctuates, stable control can be carried out by the smoothing (e.g., averaging).

As mentioned above, a current with which the compressor 4 can discharge a minimum amount of refrigerant is fine adjusted by refrigerant discharge pressure. Thus, in the every environment of the refrigerant circuit, the refrigerant discharge region of the compressor 4 can be accurately adjusted, and power saving, comfortable air conditioning, and defogging can be implemented. The examples of the environment of the refrigerant circuit include cases where the temperature of an engine room is high and heat exchange is not efficiently carried out in the condenser 11, and as a result, the refrigerant discharge pressure increases.

(Other Embodiments)

Although the present invention has been fully described in connection with the preferred embodiments thereof with reference to the accompanying drawings, it is to be noted that various changes and modifications will become apparent to those skilled in the art.

For example, in the first embodiment, the lower limit value of the second control current value Dt(n) is fixed. In the second embodiment, the lower limit value of the second control current value Dt(n) is fine-adjusted according to refrigerant discharge pressure. Instead, correction of the lower limit value may be made according to the value of applied voltage that has influence on the opening of the electromagnetic valve 4a.

As illustrated as an example in FIG. 9, the present invention may be so constructed that the ECU 15 may be provided with a voltage detection unit 19 for supply voltage, and the lower limit value of the second control current value Dt(n) may be adjusted according to a supply voltage value detected by the voltage detection unit 19. In this case, the accuracy of a threshold value at which the control flow is divided (the criterion values adopted at Steps 231 and 235 in the above embodiments) can be further enhanced. Therefore, an amount of energy consumption can be reduced without fail, and the problem that the compressor 4 does not discharge refrigerant can be prevented.

In the above embodiments, the threshold value at which the control flow is divided (the criterion values adopted at Steps 231 and 235 in the above embodiments) is the lowest value at which the electromagnetic valve 4a can operate. This value needs not be an exactly lowest value but may be a substantially lowest value. For example, even though the lowest value at which the electromagnetic valve 4 can operate is a duty of 25% in the first embodiment, 27% may be adopted as the threshold value. Even though the value is not a substantially lowest value, any other value based on the operation characteristics of the electromagnetic valve 4a is acceptable.

In the above embodiments, the control current passed through the solenoid coil 40a of the electromagnetic valve 4a is adjusted by a duty ratio. The invention is not limited to this construction as long as the current value can be controlled.

In the above embodiments, the electromagnetic valve 4a is provided in the communicating path 48 that connects the control pressure chamber 44 and the discharge chamber 46. Instead, the present invention may be so constructed that the electromagnetic valve is provided in the communicating path 47 that connects the control pressure chamber 44 and the suction chamber 45. In this case, an electromagnetic valve that is fully closed when a current is not passed can be adopted so that the compressor increases its displacement in correspondence with increase in the value of passed current.

In the above embodiments, the pressure source for adjusting the pressure in the control pressure chamber is refrigerant suction pressure and refrigerant discharge pressure. Instead, the present invention may be so constructed that any other pressure source is adopted.

In the above embodiments, the temperature sensor 26 is installed on a fin of the evaporator 14. However, the present invention is not limited to this construction as long as the temperature of air cooled at the evaporator 14 can be detected. For example, it may be installed immediately downstream of the evaporator 14 with respect to the flow of air.

In the above embodiments, the vehicle air conditioner 100 is a so-called automatic air conditioner. The invention can be applied to a manual-type air conditioner as long as it is of such type that the temperature of air cooled at the evaporator 14 is freely changed.

The actual numeric values, such as 25% and one second, cited in the description of the above embodiments are just an example. They can be appropriately set according to the characteristics of the vehicle air conditioner 100, compressor 4, electromagnetic valve 4a, and the like.

In the above-described embodiments, the present invention is typically used for the vehicle air conditioner. However, a compressor device of the present invention can be applied to a refrigerant cycle system. For example, a compression device of the present invention used for a refrigerant cycle system includes the variable displacement compressor 14 having the control pressure chamber 44, and the compressor 14 compresses and discharges refrigerant, and varies a displacement according to a pressure in the control pressure chamber 44. The electromagnetic valve 4a changes an opening such that the displacement of the refrigerant from the compressor 4 is increased in accordance with an increase in a value of current passing therethrough, and changes a pressure state applied into the control pressure chamber 44. In this case, the ECU 15 computes a target cooling load in the evaporator 14 of the refrigerant cycle system, and adjusts the value of current passing through the electromagnetic valve 4a to control the displacement. In addition, the ECU 15 sets the value of current passing through the electromagnetic valve 4a at a current value equal to or higher than a predetermined value that is determined based on an operation characteristic of the electromagnetic valve 4a. Accordingly, it is possible to set the value of current passed through the electromagnetic valve 4a to a value equal to or higher than a predetermined value based on the operation characteristics of the electromagnetic valve 4a. Thus, it is possible to avoid a state in which a current is passed with a low current value so that an electromagnetic valve 4a causes an operation start delay. Therefore, even when an electromagnetic value 4a involving an operation start delay is used, the problem that the compressor 4 does not discharge refrigerant is less prone to occur.

Because the value of passed current and the lower limit of refrigerant displacement are determined based on the operation characteristics of the electromagnetic valve 4a, the value of passed current is determined at a lower level than in cases where a lower limit of the refrigerant displacement of a compressor is determined with the emphasis on coefficient of performance COP of the refrigerant cycle system. For this reason, even when discontinuous control is carried out to repeatedly turn on and off the compressor 4 for the purpose of preventing frosting on the evaporator 14, change in the displacement of this compressor 4 does not cause great influence on fluctuation in power torque to an engine. As a result, the driver can be prevented from having uncomfortable feeling in the driving operation when the refrigerant cycle system is used for a vehicle air conditioner.

Such changes and modifications are to be understood as being within the scope of the present invention as defined by the appended claims.

What is claimed is:

1. An air conditioner for a vehicle comprising:
a heat exchanger that cools air to be blown into a compartment of the vehicle;
a temperature detecting member that detects a temperature relative to an air temperature cooled at the heat exchanger;
a variable displacement compressor having a control pressure chamber, wherein the compressor compresses and discharges refrigerant passed through the heat exchanger, and varies a displacement according to a pressure in the control pressure chamber;
an electromagnetic valve that changes an opening such that the displacement of the refrigerant is increased in accordance with an increase in a value of current passing therethrough, and changes a pressure state applied into the control pressure chamber; and
a control unit that computes a target cooling temperature used when air to be blown into the compartment is cooled by the heat exchanger, and adjusts the value of current passing through the electromagnetic valve to control the displacement so that the temperature detected by the temperature detecting member approaches to the target cooling temperature,
wherein the control unit sets the value of current passing through the electromagnetic valve at a current value equal to or higher than a predetermined value that is determined based on an operation characteristic of the electromagnetic valve.

2. The air conditioner according to claim 1, wherein the control unit sets the predetermined value at a substantially lowest value at which the electromagnetic valve is operatable.

3. The air conditioner according to claim 1, wherein the control unit sets the predetermined value at a constant value.

4. The air conditioner according to claim 1, further comprising
a discharge pressure detecting member that detects a refrigerant discharge pressure of the compressor,
wherein the electromagnetic valve is provided in a path for transmitting the refrigerant discharge pressure to the control pressure chamber, and
wherein the control unit varies the predetermined value according to the refrigerant discharge pressure detected by the discharge pressure detecting member.

5. The air conditioner according to claim 4, wherein the control unit varies the predetermined value according to a value obtained by subjecting the refrigerant discharge pressure detected by the discharge pressure detecting member to a time constant smoothing.

6. The air conditioner according to claim 1, wherein the control unit varies the predetermined value according to the value of voltage applied to the electromagnetic valve.

7. The air conditioner according to claim 1, wherein the temperature detecting member directly detects a temperature of air cooled by the heater exchanger.

8. The air conditioner according to claim 1, wherein:
the heat exchanger includes a plurality of tubes in which refrigerant flows, and a plurality of fins between the tubes; and
the temperature detecting member detects a temperature of the fin.

9. A compression device for a refrigerant cycle system, comprising:
a variable displacement compressor having a control pressure chamber, wherein the compressor compresses and discharges refrigerant, and varies a displacement according to a pressure in the control pressure chamber;
an electromagnetic valve that changes an opening such that the displacement of the refrigerant from the compressor is increased in accordance with an increase in a value of current passing therethrough, and changes a pressure state applied into the control pressure chamber; and
a control unit that computes a target cooling load in a heat exchanger of the refrigerant cycle system, and adjusts the value of current passing through the electromagnetic valve to control the displacement;
wherein the control unit sets the value of current passing through the electromagnetic valve at a current value equal to or higher than a predetermined value that is determined based on an operation characteristic of the electromagnetic valve.

10. The air conditioner according to claim 9, wherein the control unit sets the predetermined value at a substantially lowest value at which the electromagnetic valve is operatable.
